(19) United States
(12) Patent Application Publication
(10) Pub. No.: US 2025/0188706 A1
(43) Pub. Date: Jun. 12, 2025

(54) OPERATION SYSTEM AND WORK MACHINE

(71) Applicant: YANMAR HOLDINGS CO., LTD., Osaka (JP)

(72) Inventor: Junya ONO, Fukuoka (JP)

(73) Assignee: YANMAR HOLDINGS CO., LTD., Osaka (JP)

(21) Appl. No.: 18/929,808

(22) Filed: Oct. 29, 2024

(30) Foreign Application Priority Data
Dec. 6, 2023 (JP) 2023-205809

(51) Int. Cl. E02F 9/20; E02F 3/96; E02F 9/22

(52) U.S. Cl. CPC E02F 9/2004; E02F 3/964; E02F 9/2033; E02F 9/205; E02F 9/2271; E02F 9/2203; E02F 9/2285

(57) ABSTRACT

To provide an operation system for a work machine, and a work machine in which it is easy to improve operability of a soil removal device. An operation system is an operation system for a work machine provided with a soil removal device including a blade. The operation system includes an operation lever, a first operation element, and a second operation element. The operation lever accepts a lifting operation for causing the blade to perform lifting movement. The first operation element accepts an operation for causing the blade to perform angle movement of rotationally swinging the blade around a first axis along a vertical direction. The second operation element accepts an operation for causing the blade to perform tilt movement of rotationally swinging the blade around a second axis along a horizontal direction. The first operation element and the second operation element are individually provided.

This application claims priority under 35 U.S.C. § 119 to Japanese Patent Application No. 2023-205809, filed on Dec. 6, 2023, which is incorporated by reference.

### TECHNICAL FIELD

The present invention relates to an operation system for a work machine provided with a soil removal device including a blade, and a work machine.

### BACKGROUND ART

As a related art, there is known a work machine (hydraulic shovel) provided with a soil removal device, and a blade operation device that operates a blade of the soil removal device (e.g., see Patent Document 1). The soil removal device includes a blade, a blade lifting cylinder, an angle cylinder, and a tilt cylinder. The blade operation device includes a (blade) operation lever that operates the blade lifting cylinder by tilting the cylinder in a front-rear direction, and a tilt/angle operation switch and a cylinder selection switch provided on the operation lever.

In the blade operation device, a cylinder to be operated by the tilt/angle operation switch is selected by the cylinder selection switch. When the tilt/angle operation switch is operated in a state where the angle cylinder is selected, the work machine performs angle movement of swinging lengthwise both ends of the blade in a front-rear direction. When the tilt/angle operation switch is operated in a state where the tilt cylinder is selected, the work machine performs tilt movement of swinging the lengthwise both ends of the blade in an up-down direction.

### PRIOR ART DOCUMENT

### Patent Document

Patent Document 1: Japanese Patent Application Publication No. 2019-167686

### SUMMARY OF INVENTION

### Technical Problem

In the work machine according to the above-described related art, for example, in a case where tilt movement is performed after angle movement is performed, it is necessary to perform an operation by the tilt/angle operation switch after the cylinder selection switch is operated. Therefore, the operation become cumbersome to an operator, and there is a possibility that an erroneous operation due to misunderstanding of a cylinder in selection may occur.

An object of the present invention is to provide an operation system for a work machine, and a work machine in which it is easy to improve operability of a soil removal device.

### Solution to Problem

An operation system according to one aspect of the present invention is an operation system for a work machine provided with a soil removal device including a blade. The operation system includes an operation lever, a first operation element, and a second operation element. The operation lever accepts a lifting operation for causing the blade to perform lifting movement. The first operation element accepts an operation for causing the blade to perform angle movement of rotationally swinging the blade around a first axis along a vertical direction. The second operation element accepts an operation for causing the blade to perform tilt movement of rotationally swinging the blade around a second axis along a horizontal direction. The first operation element and the second operation element are provided individually.

A work machine according to one aspect of the present invention includes the above-described operation system, and a machine body including the soil removal device.

### Advantageous Effects of Invention

According to the present invention, it is possible to provide an operation system for a work machine, and a work machine in which it is easy to improve operability of a soil removal device.

### BRIEF DESCRIPTION OF DRAWINGS

FIG. 1 is a schematic perspective view illustrating an overall configuration of a work machine according to a first embodiment.

FIG. 2 is a schematic plan view illustrating an overall configuration of the work machine according to the first embodiment.

FIG. 3 is a schematic front view illustrating an overall configuration of the work machine according to the first embodiment.

FIG. 4 is a schematic perspective view illustrating an inner portion of a driving unit of the work machine according to the first embodiment.

FIG. 5 is a schematic diagram illustrating a hydraulic circuit and the like of the work machine according to the first embodiment.

FIG. 6 is a schematic view illustrating an operation lever of the work machine according to the first embodiment.

FIG. 7 is a state transition diagram illustrating a movement example of an operation system for the work machine according to the first embodiment.

### DESCRIPTION OF EMBODIMENTS

In the following, an embodiment according to the present invention is described with reference to the accompanying drawings. The following embodiment is an example embodying the present invention, and does not limit the technical scope of the present invention.

### First Embodiment

### [1] Overall Configuration

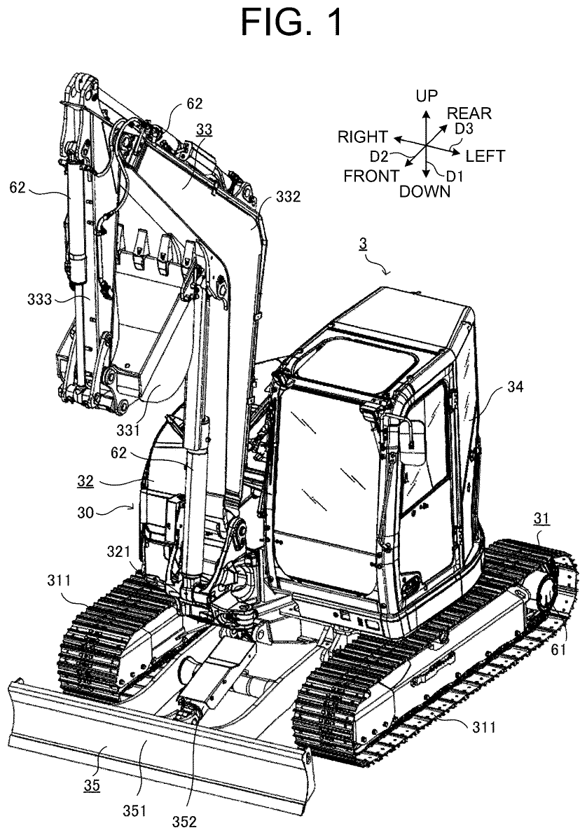

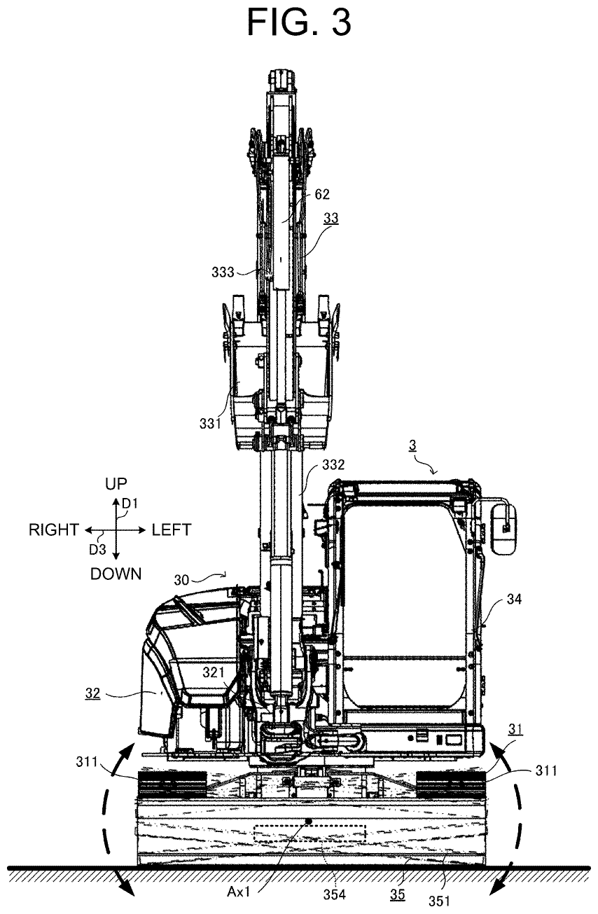

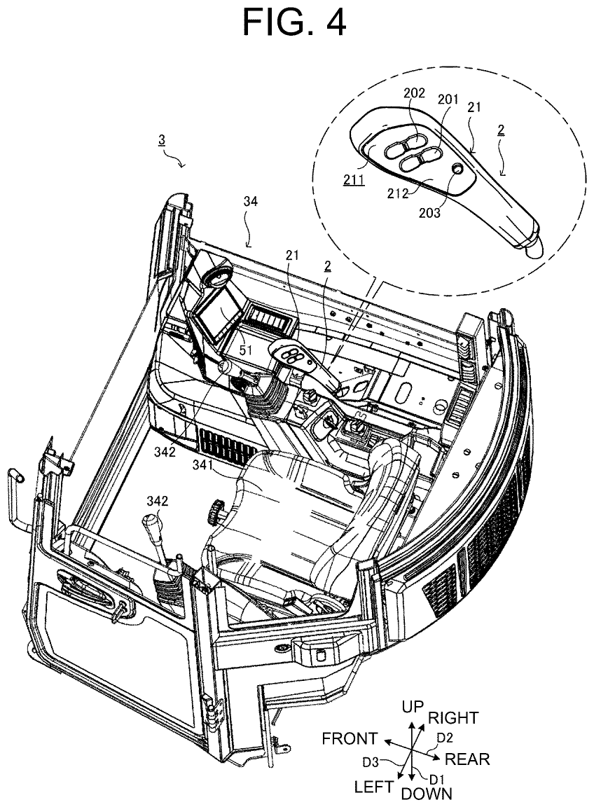

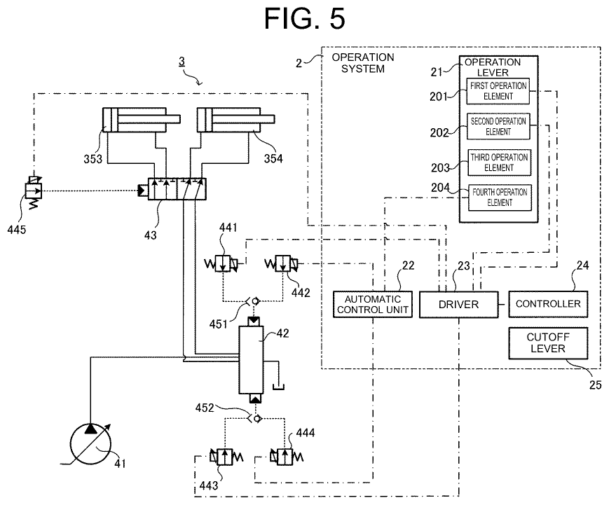

As illustrated in FIGS. 1 and 3, a work machine 3 according to the present embodiment includes a traveling unit 31, a turning unit 32, a work unit 33, and a soil removal device 35. The work machine 3 further includes a driving unit 34 that a passenger can get in. As illustrated in FIG. 4, the driving unit 34 includes a driver's seat 341, which is a seat in which a passenger sits, and the like. In the present embodiment, it is assumed that the traveling unit 31, the turning unit 32, the work unit 33, the soil removal device 35, and the driving unit 34 are included in a machine body 30 of the work machine 3. Further, as illustrated in FIG. 5, the work machine 3 further includes an operation system 2. That is, the work machine 3 according to the present embodiment includes the operation system 2, and the machine body 30 including the soil removal device 35.

A “work machine” mentioned in the present disclosure means a machine for various pieces of work, and, as an example, is a work vehicle such as a backhoe (including a hydraulic shovel, a miniature shovel, and the like), a wheel loader, and a carrier. The work machine 3 includes the work unit 33 that is configured to be able to perform one or more pieces of work. The work machine 3 is not limited to a “vehicle”, and, for example, may be a work vessel, a work flying object such as a drone or a multicopter, and the like. Further, the work machine 3 is not limited to a construction machine (construction machinery), and, for example, may be an agricultural machine (agricultural machinery) such as a rice planting machine, a tractor, or a combine. In the present embodiment, unless otherwise specifically noted, a case where the work machine 3 is a ride-on type backhoe, and excavation work, ground leveling work, trench digging work, loading work, or the like can be performed as work is described as an example. More specifically, the work machine 3 according to the present embodiment is assumed to be an “ultra-small turning type” in which the turning unit 32 including the work unit 33 can make a full turn within 120% of the entire width (entire width of a pair of left and right crawlers 311) of the traveling unit 31, or a “rearward ultra-small turning type” in which a turning radius ratio at a rear end is within 120%.

Further, in the present embodiment, as an example, it is assumed that a passenger getting in the driving unit 34 is an operator, and the work machine 3 is moved by an operator's operation. However, the embodiment is not limited to this example, and, for example, the work machine 3 may be movable by a remote operation or autonomous driving. Further, a plurality of passengers may be able to get in the driving unit 34 at the same time. In this case, a plurality of driver's seats 341 may be provided in one driving unit 34.

For convenience of explanation, in the present embodiment, a vertical direction in a state that the work machine 3 is ready for use is defined as an up-down direction D1. Furthermore, a front-rear direction D2 and a left-right direction D3 are defined with respect to a direction viewed from an operator getting in the driving unit 34 of the work machine 3, as a reference. In other words, each direction used in the present embodiment is a direction that is determined with respect to the driving unit 34 of the work machine 3 as a reference, and a direction in which the machine body 30 moves during forward travel of the work machine 3 is a “front side”, and a direction in which the machine body 30 moves during backward travel of the work machine 3 is a “rear side”. Likewise, a direction in which a front end portion of the machine body 30 moves during right turn of the work machine 3 is a “right side”, and a direction in which the front end portion of the machine body 30 moves during left turn of the work machine 3 is a “left side”. Since the driving unit 34 is provided in the turning unit 32, the front-rear direction D2 and the left-right direction D3 with respect to the traveling unit 31 change as the turning unit 32 turns. In the following, as illustrated in FIG. 1, a direction is defined in a state in which a front surface of the driving unit 34 faces a traveling direction of the traveling unit 31. However, these directions are not intended to limit a direction of use (direction in use) of the work machine 3.

The work machine 3 includes an engine serving as a power source. In the present embodiment, as an example, the engine is a diesel engine. The engine is driven when fuel (herein, light oil) is supplied from a fuel tank. In the work machine 3, for example, a hydraulic pump 41 (see FIG. 5) is driven by the engine, and hydraulic oil is supplied from the hydraulic pump 41 to a hydraulic actuator (including a hydraulic motor 61, a lifting cylinder 352, an angle cylinder 353, a tilt cylinder 354, and the like) of each unit of the machine body 30, whereby the machine body 30 is driven. The work machine 3 as described above is controlled, for example, when an operator getting in the driving unit 34 of the machine body 30 operates an operation lever 21 (see FIG. 4) and the like of the operation system 2 (see FIG. 4).

In the present embodiment, as described above, it is assumed that the work machine 3 is a ride-on type backhoe. Therefore, the work unit 33 is driven in response to an operation of an operator getting in the driving unit 34, and performs work such as excavation work. The work unit 33 is supported by the turning unit 32 in which the driving unit 34 is provided. Therefore, at a time of turning the turning unit 32, the work unit 33 turns together with the driving unit 34.

Herein, as illustrated in FIG. 4, the operation lever 21, a display device 51, and the like are loaded in the driving unit 34 of the machine body 30, and an operator can operate the operation lever 21 and the like, while viewing various pieces of information related to the work machine 3 to be displayed on the display device 51. As an example, an operator can confirm, on the display device 51, information related to an operating condition of the work machine 3 necessary for operating the operation element system 2 by causing to display, on a display screen of the display device 51, information related to an operating condition of the work machine 3, such as a cooling water temperature, and a hydraulic oil temperature.

The traveling unit 31 includes a traveling function, and is configured to be able to travel on the ground (including turning). The traveling unit 31 includes, for example, the pair of left and right crawlers 311, and the like. The traveling unit 31 further includes, as a hydraulic actuator, the hydraulic motor 61 and the like for traveling to drive the crawlers 311.

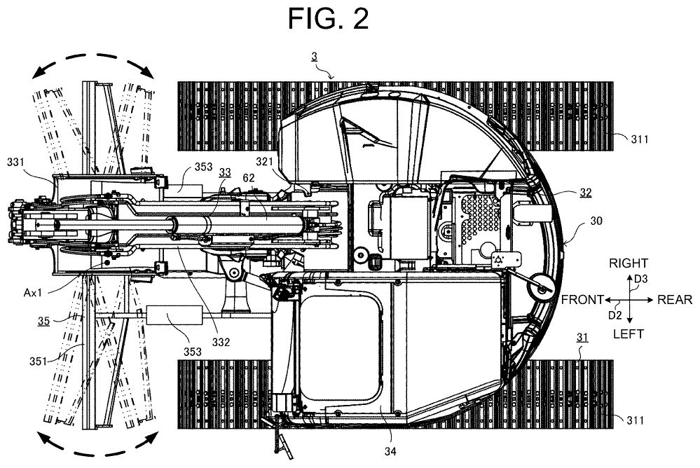

The soil removal device 35 is disposed at a front end portion of the machine body 30. The soil removal device 35 includes the blade 351, the lifting cylinder 352, the angle cylinder 353 (see FIG. 2), and the tilt cylinder 354 (see FIG. 3).

The blade 351 is disposed at a front position of the traveling unit 31. The blade 351 is formed into a rectangular shape having a length in the left-right direction D3 in a front view (see FIG. 3). The soil removal device 35 performs soil removal work of soil, sand, and the like by the blade 351.

The blade 351 is movable relative to a frame (traveling unit 31) of the machine body 30. Specifically, the blade 351 can perform three kinds of movement, i.e., lifting movement, angle movement, and tilt movement.

The lifting movement is movement of moving the blade 351 in the up-down direction D1. That is, the blade 351 is movable between an upper end position and a lower end position within a lifting range by lifting movement.

The lifting cylinder 352 is a hydraulic cylinder for performing lifting movement of the blade 351. The blade 351 is moved from an upper end position toward a lower end position by lowering the blade 351 by the lifting cylinder 352. The blade 351 is moved from a lower end position toward an upper end position by raising the blade 351 by the lifting cylinder 352.

As illustrated in FIG. 2, the angle movement is movement of rotationally swinging the blade 351 around a first axis Ax1 (see FIG. 2) along a vertical direction (up-down direction D1). That is, the blade 351 moves one end portion thereof in the left-right direction D3 in the front-rear direction D2 by angle movement. Thus, a rotation angle of the blade 351 around the first axis Ax1, i.e., an inclination of the blade 351 in a plan view can be adjusted. The first axis Ax1 is a virtual axis, and may or may not be tangible.

The angle cylinder 353 is a hydraulic cylinder for performing angle movement of the blade 351. By rotating the blade 351 clockwise in a plan view by the angle cylinder 353, a left end portion of the blade 351 is located at a front position relative to a right end portion thereof. By rotating the blade 351 counterclockwise in a plan view by the angle cylinder 353, a right end portion of the blade 351 is located at a front position relative to a left end portion thereof.

As illustrated in FIG. 3, the tilt movement is movement of rotationally swinging the blade 351 around a second axis Ax2 along a horizontal direction (front-rear direction D2). That is, the blade 351 moves one end portion thereof in the left-right direction D3 in the up-down direction D1 by tilt movement. Thus, a rotation angle of the blade 351 around the second axis Ax2, that is, an inclination of the blade 351 in a front view can be adjusted. The second axis Ax2 is a virtual axis, and may or may not be tangible.

The tilt cylinder 354 is a hydraulic cylinder for performing tilt movement of the blade 351. By rotating the blade 351 clockwise in a plan view by the tilt cylinder 354, a right end portion of the blade 351 is located at an upper position relative to a left end portion thereof. By rotating the blade 351 counterclockwise in a plan view by the tilt cylinder 354, a left end portion of the blade 351 is located at an upper position relative to a right end portion thereof.

Then, in a case where the work machine 3 performs soil removal work of soil, sand, and the like, the blade 351 is made contact with the ground by lowering the blade 351 by the lifting cylinder 352. Causing the work machine 3 to travel in this state enables to level the ground by the blade 351.

Further, in the work machine 3, causing the blade 351 to perform angle movement by the angle cylinder 353, for example, by locating a left end portion of the blade 351 at a front position with respect to a right end portion thereof enables to discharge soil and sand scraped off by the blade 351 to the right side of the traveling unit 31. Further, in the work machine 3, causing the blade 351 to perform tilt movement by the tilt cylinder 354 enables to adjust a contact angle of the blade 351 with respect to the ground.

The turning unit 32 is disposed above the traveling unit 31, and can turn with respect to the traveling unit 31 in a plan view. That is, the turning unit 32 is located above the traveling unit 31, and is configured to be able to turn with respect to the traveling unit 31 around a rotation axis along a vertical direction. The turning unit 32 includes a hydraulic motor as a hydraulic actuator for turning, and the like. An engine, a hydraulic pump, and the like are loaded in the turning unit 32, in addition to the driving unit 34. Further, a boom bracket on which the work unit 33 is mounted is provided in the turning unit 32. The turning unit 32 has a substantially circular shape, in a plan view, in which a front end portion thereof is cut out into a flat shape. The turning unit 32 can turn around a center of the circular shape, as a rotation axis.

The work unit 33 is supported by the turning unit 32, and is configured to be able to perform one or more pieces of work. The work unit 33 is supported by a boom bracket of the turning unit 32, and performs work. The work unit 33 includes a bucket 331. The bucket 331 is one kind of an attachment (work implement) to be mounted on the machine body 30 of the work machine 3, and is constituted of any implement to be selected according to a content of work from among a plurality of kinds of attachments. As an example, the bucket 331 is mounted to be detachable from the machine body 30, and is replaced according to a content of work. Examples of an (end) attachment for the work machine 3 include, in addition to the bucket 331, various implements, such as a breaker, an auger, a crusher, a fork, a fork claw, a steel frame cutter, an asphalt cutting machine, a grass cutter, a ripper, a mulcher, a tilt rotator, and a tamper.

The work unit 33 further includes a boom 332, an arm 333, and hydraulic actuators (including the hydraulic cylinder 62, a hydraulic motor, and the like), and the like. The bucket 331 is mounted on a leading end of the arm 333. The bucket 331 is supported to be rotatable with respect to the arm 333 around a rotation axis along a horizontal direction.

The boom 332 is supported to be rotatable by a boom bracket of the turning unit 32. Specifically, the boom 332 is supported to be rotatable by the boom bracket around a rotation axis along a horizontal direction. The boom 332 has a shape extending upward from a base end portion supported by the boom bracket. The arm 333 is coupled to a leading end of the boom 332. The arm 333 is supported to be rotatable with respect to the boom 332 around a rotation axis along a horizontal direction.

The work unit 33 is operated by receiving power from the engine as a power source. Specifically, the hydraulic pump 41 is driven by the engine, and hydraulic oil is supplied from the hydraulic pump 41 to hydraulic actuators (the hydraulic cylinder 62, and the like) of the work unit 33, thereby causing each part (the bucket 331, the boom 332, and the arm 333) of the work unit 33 to move.

In the present embodiment, particularly, the work unit 33 has a multi-joint structure in which the boom 332 and the arm 333 are configured to be individually rotatable. That is, the multi-joint work unit 33 including the boom 332 and the arm 333 is able to perform, for example, stretching or folding movement as a whole by rotating each of the boom 332 and the arm 333 around a rotation axis along a horizontal direction. Further, the bucket 331 as an attachment is supported with respect to the machine body 30 (turning unit 32) via the boom 332 and the arm 333, and the bucket 331 can be opened and closed by rotating the bucket 331 itself with respect to the arm 333.

Each of the traveling unit 31 and the turning unit 32 is also moved by receiving power from the engine as a power source, as well as the work unit 33. That is, the turning unit 32 and the traveling unit 31 are moved when hydraulic oil is supplied from the hydraulic pump 41 to the hydraulic motor 61 of the traveling unit 31, a hydraulic motor of the turning unit 32, and the like.

The work machine 3 further includes a driving device (mechanism) such as a power take-off (PTO) device for supplying power to the bucket 331 (attachment). Specifically, the driving device sends, to the bucket 331, hydraulic oil from a hydraulic pump to be driven by the engine, and adjusts a magnitude of power to be supplied to the bucket 331 by adjusting a flow rate of the hydraulic oil.

As illustrated in FIG. 4, the driving unit 34 is a space for allowing an operator to get in, and is located above the turning unit 32 in the present embodiment. Therefore, when the turning unit 32 turns in a plan view, the driving unit 34 also turns together with the turning unit 32. Specifically, in a case where the turning unit 32 is divided into two parts in the left-right direction D3, the driving unit 34 is provided in a left portion of the turning unit 32. The driving unit 34 includes at least the driver's seat 341 in which an operator is seated.

As a kind of the driving unit 34 of the work machine 3 such as a construction machine, there are a cabin type, a canopy type, a floor type, and the like. The driving unit 34 of a cabin type includes a cabin, and an operator gets in a cabin space inside the cabin. The driving unit 34 of a canopy type includes a canopy (roof), and an operator gets in a space below the canopy. The driving unit 34 of a floor type does not include the cabin, a canopy, and the like, and an operator gets in a space opened upward. That is, the driving unit 34 may include not only a configuration in which surroundings are surrounded by a panel or the like, but also various configurations prepared as a space that an operator can get in. In the present embodiment, a case where the driving unit 34 is a cabin type is described as an example.

In the present embodiment, the driving unit 34 is located above the left crawler 311 (see FIG. 1). This arrangement allows an operator to get in and out of the driving unit 34 from the left side of the driving unit 34. Therefore, in the present embodiment, a door of the driving unit 34 is disposed on the left side of the driving unit 34 in the left-right direction D3. That is, an operator gets in and out of the driving unit 34 through a door disposed on the left side of the driving unit 34.

The operation system 2 is installed in the driving unit 34 of the machine body 30, and is a user interface for accepting an operation input by a user (operator), and operating the work machine 3. As illustrated in FIG. 4, the operation system 2 includes the operation lever 21 for operating the soil removal device 35, a pair of levers 342 disposed at both sides of the driver's seat 341 in the left-right direction D3, and the like.

The pair of levers 342 are located on both sides of a front end portion of the driver's seat 341 in the left-right direction D3. Therefore, an operator seated in the driver's seat 341, for example, holds one of the levers 342 with his/her right hand, holds the other of the levers 342 with his/her left hand, and causes the work machine 3 to perform various movements by operating the pair of levers 342.

The operation lever 21 is located on one side of the front end portion of the driver's seat 341 in the left-right direction D3. Herein, the operation lever 21 is located outside of the pair of levers 342. In the present embodiment, as an example, the operation lever 21 is located further on the right side of the right lever 342, that is, on a side opposite to the driver's seat 341 when viewed from the lever 342. Therefore, an operator in a seated state in the driver's seat 341 holds the operation lever 21, for example, with his/her right hand, and causes (the blade 351 of) the soil removal device 35 to perform various movements by operating the operation lever 21. Details on the operation lever 21 are described in the column “[3] Configuration of Operation Lever”.

The display device 51 is disposed in the driving unit 34, and is a user interface for outputting various pieces of information to an operator. The display device 51 is controlled by the control system 1, and presents (outputs) various pieces of information by displaying various screens. The display device 51 may include a function of outputting sounds (including voice), in addition to display, and present various pieces of information by sounds. Further, in the present embodiment, the display device 51 includes an input means such as a touch panel, and accepts various operations by an operator by outputting an electrical signal in response to an operator's operation. This allows an operator to visually recognize a display screen to be displayed on the display device 51, and operate the display device 51 according to needs.

In addition to the above-described configuration, the machine body 30 further includes a control device, a sound output unit, a communication terminal, a cutoff lever, a fuel tank, a battery, various sensors for detecting a detection target object in a monitoring area around the work machine 3, such as a camera that images surroundings of the machine body 30, and the like. Further, the machine body 30 includes sensors (including a camera) for monitoring an operating condition of the machine body 30, such as a cooling water temperature sensor, a hydraulic oil temperature sensor, a tachometer that measures a rotational speed of the engine, and an hour meter that measures working hours.

### [2] Configuration of Hydraulic Circuit

Next, a configuration of a hydraulic circuit of the work machine 3 according to the present embodiment is described with reference to FIG. 5. In FIG. 5, solid lines represent high-pressure oil paths (for hydraulic oil), dotted lines represent low-pressure oil paths (for pilot oil), and dashed-dotted line arrows represent electric signal paths.

As illustrated in FIG. 5, the work machine 3 includes the angle cylinder 353, the tilt cylinder 354, the hydraulic pump 41, a direction switching valve (control valve) 42, a switching valve 43, a plurality of control valves 441 to 445, and a plurality of shuttle valves 451 and 452. The work machine 3 further includes, as the operation system 2, an automatic control unit 22, a driver 23, a controller 24, and a cutoff lever 25, in addition to the above-described operation lever 21. FIG. 5 illustrates a hydraulic circuit associated with the angle cylinder 353 that causes the blade 351 to perform angle movement, and the tilt cylinder 354 that causes the blade 351 to perform tilt movement, and illustration of other hydraulic circuits is omitted as necessary.

The direction switching valve 42 is a pilot-type direction switching valve capable of switching a direction and a flow rate of hydraulic oil from the hydraulic pump 41, and is driven by supply of a pilot signal (pilot oil) serving as an input command from a pilot pump. Specifically, the direction switching valve 42 switches whether to flow hydraulic oil from the hydraulic pump 41 to the switching valve 43. The four control valves 441 to 444 are provided on a pilot oil supply path to the direction switching valve 42.

The control valves 441 and 442 are connected to the direction switching valve 42 via the shuttle valve 451, and the control valves 443 and 444 are connected to the direction switching valve 42 via the shuttle valve 452. Therefore, a pilot signal on a high-pressure side between the control valves 441 and 442 is input to the direction switching valve 42, and a pilot signal on a high-pressure side between the control valves 443 and 443 is input to the direction switching valve 42.

The switching valve 43 switches a supply destination of hydraulic oil from the hydraulic pump 41 between the angle cylinder 353 and the tilt cylinder 354 via the direction switching valve 42. The control valve 445 is provided on a pilot oil supply path to the switching valve 43. That is, the control valve 445 can switch a supply destination of hydraulic oil from the hydraulic pump 41 between the angle cylinder 353 and the tilt cylinder 354.

Any of the control valves 441 to 445 is constituted of an electromagnetic control valve (solenoid valve). Herein, it is assumed that each of the control valves 441 to 445 is a (solenoid type) proportional control valve. However, the embodiment is not limited thereto, and any of the control valves 441 to 445 may be, for example, an on/off valve capable of switching open/shut-off of a flow path.

The control valves 441 and 443 are electrically connected to the driver 23, and operated in response to a control signal from the driver 23. The control valves 442 and 444 are electrically connected to the automatic control unit 22, and operated in response to a control signal from the automatic control unit 22. The control valve 445 is electrically connected to the driver 23, and operated in response to a control signal from the driver 23.

Herein, as illustrated in FIG. 5, the operation system 2 includes a first operation element 201, a second operation element 202, a third operation element 203, and a fourth operation element 204. Although details will be described later, in the present embodiment, as an example, any of the first operation element 201, the second operation element 202, the third operation element 203, and the fourth operation element 204 is provided on the operation lever 21. Any of the first operation element 201, the second operation element 202, the third operation element 203, and the fourth operation element 204 is an electric-type operation element, and accepts various operations by an operator by outputting an electrical signal (operation signal) in response to an operator's operation.

The first operation element 201 and the second operation element 202 are electrically connected to the driver 23. The fourth operation element 204 is electrically connected to the automatic control unit 22.

At an operation time of the first operation element 201 or the second operation element 202, the driver 23 controls the control valves 441 and 443 in response to an operation of the first operation element 201 or the second operation element 202 in such a way as to open the control valves 441 and 443. Further, at an operation time of the first operation element 201, the driver 23 controls the control valve 445 in response to an operation of the first operation element 201 in such a way as to open the control valve 445.

Meanwhile, the automatic control unit 22 switches between an automatic control mode and a manual control mode in response to an operation of the fourth operation element 204. In the automatic control mode, the automatic control unit 22 automatically controls the control valves 442 and 444 so as to automatically perform at least tilt movement of the blade 351.

The controller 24 includes, as a main component, a computer system including, for example, one or more processors such as a central processing unit (CPU), and one or more memories such as a read only memory (ROM) and a random access memory (RAM), and executes various pieces of processing (information processing). In the present embodiment, the controller 24 is an integral controller that performs overall control of the work machine 3, and is, for example, configured of an electronic control unit (ECU). However, the controller 24 may be provided independently of an integral controller, or may include, as a main component, one processor or a plurality of processors.

In the present embodiment, as an example, since the controller 24 includes, as a main component, a computer system including one or more processors, various functions as the controller 24 are achieved by causing the one or more processors to execute a control program. The plurality of functions included in the controller 24 may be provided in a plurality of housings in a distributive manner, or may be provided in one housing. For example, the plurality of functions included in the controller 24 may be provided in the automatic control unit 22 and/or the driver 23, or conversely, at least some of the functions of the automatic control unit 22 and/or the driver 23 may be provided in the controller 24.

In the present embodiment, as described above, at an operation time of the first operation element 201 or the second operation element 202, by controlling at least the driver 23, the controller 24 causes the driver 23 to control the control valves 441 and 443 in response to an operation of the first operation element 201 or the second operation element 202 in such a way as to open the control valves 441 and 443. Further, at an operation time of the first operation element 201, the controller 24 causes the driver 23 to control the control valve 445 in response to an operation of the first operation element 201 in such a way as to open the control valve 445.

The cutoff lever 25 switches between a locked state in which movement of the work machine 3 is restricted, and a lock released state in which movement of the work machine 3 is not restricted. The cutoff lever 25 is disposed in the driving unit 34 of the machine body 30, and accepts an operation input by an operator. In the present embodiment, as an example, the cutoff lever 25 is operable along the up-down direction D1. In a case where the cutoff lever 25 is at an “up position” being an upper end position in a movable range, the work machine 3 is brought to a locked state. On the other hand, in a case where the cutoff lever 25 is at a “down position” being a lower end position in the movable range, the work machine 3 is brought to a lock released state.

Specifically, in a locked state in which the cutoff lever 25 is at an “up position”, by closing a control valve provided on a pilot signal (pilot oil) supply path from a pilot pump, a hydraulic actuator is forcibly stopped. Therefore, to drive the hydraulic actuator, an operator is required to operate the cutoff lever 25 to a “down position”. As far as the cutoff lever 25 is at an “up position”, all of the traveling unit 31, the turning unit 32, the work unit 33, and the soil removal device 35 are brought to a forcible driving disabled state (locked state). The cutoff lever 25 is a lever to be operated when movement of the work machine 3 is locked as described above, and is equivalent to a gate lock lever.

### [3] Configuration of Operation Lever

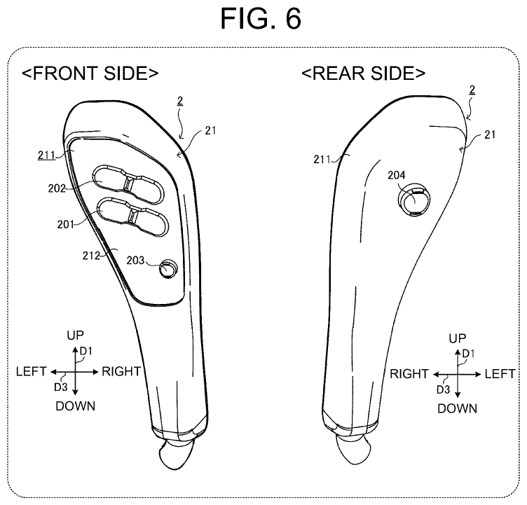

Next, a configuration of the operation lever 21 according to the present embodiment is described with reference to FIG. 6. In FIG. 6, only the operation lever 21 is illustrated, and illustration of the other components is omitted.

In the present embodiment, since the operation lever 21 is an operation tool of a lever type, a pose (such as an orientation) of the operation lever 21 is changed as necessary by an operation accompanying movement of a grip portion 211. Therefore, a pose of the operation lever 21 may be changed as necessary with respect to the up-down direction D1, the front-rear direction D2, and the left-right direction D3 that are determined with respect to the machine body 30 of the work machine 3, as a reference. In the following, as illustrated in FIG. 6, a pose of the operation lever 21 is described based on an assumption that a longitudinal direction of the grip portion 211 coincides with the up-down direction D1, and an operation surface 212 of the grip portion 211 is in a state facing rearward.

The operation lever 21 includes the grip portion 211, the first operation element 201, the second operation element 202, the third operation element 203, and the fourth operation element 204.

The grip portion 211 is a portion to be gripped by an operator, and, in the present embodiment, as an example, has a shape having a length in one direction (up-down direction D1). The operation lever 21 is capable of accepting a lifting operation accompanying movement of the grip portion 211. A “lifting operation” mentioned herein is an operation for causing the blade 351 of the soil removal device 35 to perform lifting movement. That is, the operation lever 21 accepts a lifting operation for causing the blade 351 to perform lifting movement.

Upon accepting a lifting operation in such a way as to move the grip portion 211 along the front-rear direction D2 by an operator, the operation lever 21 performs a lifting operation by the lifting cylinder 352 in such a way as to raise and lower the blade 351 according to an operation amount of the operation lever 21. In the present embodiment, as described above, as an example, since the operation lever 21 is disposed on the right side of the driver's seat 341, normally, the operation lever 21 is operated by the right hand of an operator seated in the driver's seat 341.

The grip portion 211 includes the operation surface 212 on one surface thereof. The operation surface 212 is a surface on which the first operation element 201, the second operation element 202, and the third operation element 203 are disposed. In the present embodiment, as an example, the operation surface 212 is provided, on a surface of the grip portion 211, on a side of an operator seated in the driver's seat 341, that is, on a portion (back surface) facing rearward. Herein, the operation surface 212 is a flat surface, but the operation surface 212 is not limited to a flat surface, and may include, for example, a curved surface, a step, or the like.

The fourth operation element 204 is provided on a surface of the grip portion 211 opposite to the side of the operation surface 212 of the grip portion 211, that is, on a portion (front surface) facing rearward. In this way, the first operation element 201, the second operation element 202, the third operation element 203, and the fourth operation element 204 are provided on the grip portion 211 of the operation lever 21.

Any of the first operation element 201, the second operation element 202, the third operation element 203, and the fourth operation element 204 is constituted of a mechanical switch such as a slide switch, a seesaw switch, a push button switch, or a joystick. In the present embodiment, as an example, each of the first operation element 201 and the second operation element 202 is a slide switch, and each of the third operation element 203 and the fourth operation element 204 is a push button switch. Herein, the following operation is allocated to each of the first operation element 201, the second operation element 202, the third operation element 203, and the fourth operation element 204.

An angle operation for causing the blade 351 to perform angle movement is allocated to the first operation element 201. That is, angle movement of the blade 351 is performed according to an operation direction and an operation amount of the first operation element 201 constituted of a slide switch.

A tilt operation for causing the blade 351 to perform tilt movement is allocated to the second operation element 202. That is, tilt movement of the blade 351 is performed according to an operation direction and an operation amount of the second operation element 202 constituted of a slide switch.

A vehicle speed switching operation for switching a vehicle speed of the traveling unit 31 of the work machine 3 is allocated to the third operation element 203. That is, a vehicle speed of the traveling unit 31 is switched by a plurality of stages including a first gear and a second gear, each time the third operation element 203 constituted of a push button is pushed.

A mode switching operation for switching between the automatic control mode and the manual control mode of the automatic control unit 22 is allocated to the fourth operation element 204. That is, the automatic control mode in which the automatic control unit 22 automatically controls the blade 351, and the manual control mode in which the blade 351 is manually controlled are switched, each time the fourth operation element 204 constituted of a push button switch is pushed. Herein, only tilt movement and lifting movement of the blade 351 are automatically controlled in the automatic control mode, and angle movement of the blade 351 is not automatically performed.

As described above, the operation system 2 according to the present embodiment is the operation system 2 for the work machine 3 provided with the soil removal device 35 including the blade 351, and includes the operation lever 21, the first operation element 201, and the second operation element 202. The operation lever 21 accepts a lifting operation for causing the blade 351 to perform lifting movement. The first operation element 201 accepts an operation (angle operation) for causing the blade 351 to perform angle movement of rotationally swinging the blade 351 around the first axis Ax1 along a vertical direction (up-down direction D1). The second operation element 202 accepts an operation (tilt operation) for causing the blade 351 to perform tilt movement of rotationally swinging the blade 351 around the second axis Ax2 along a horizontal direction. Herein, the first operation element 201 and the second operation element 202 are provided individually.

That is, the first operation element 201 for accepting an angle operation, and the second operation element 202 for accepting a tilt operation are provided independently of each other. Therefore, for example, in a case where tilt movement is performed after angle movement is performed, like a case where an angle operation and a tilt operation are allocated to a single operation element, it is not necessary to perform an operation (operation of a cylinder selection switch) for switching a function of the operation element. Therefore, an operation is made easy to an operator, and it is less likely that an erroneous operation resulting from misunderstanding of a cylinder in selection (the angle cylinder 353/the tilt cylinder 354) may occur. Consequently, according to the operation system 2, there is an advantage that it is easy to improve operability of the soil removal device 35.

Further, as illustrated in FIG. 6, the first operation element 201 and the second operation element 202 are disposed adjacent to each other. That is, the first operation element 201 and the second operation element 202 are disposed in proximity to each other on a same surface, and in a state in which another operation element does not intervene between the first operation element 201 and the second operation element 202. This makes it easy for an operator to operate the first operation element 201 and the second operation element 202 with the same finger, despite that the first operation element 201 and the second operation element 202 are provided individually, and operability of the first operation element 201 and the second operation element 202 is improved.

Further, the first operation element 201 and the second operation element 202 are disposed on the grip portion 211 of the operation lever 21. Thus, operations associated with the blade 351 are consolidated on the operation lever 21, which makes it easy for an operator to intuitively recognize an operation of the blade 351.

Further, the first operation element 201 and the second operation element 202 are disposed side by side in a longitudinal direction (up-down direction D1) of the grip portion 211. In the present embodiment, as an example, the first operation element 201 is located at a lower position, and the second operation element 202 is located at an upper position. Therefore, an operator can operate the first operation element 201 and the second operation element 202, while gripping substantially with the same hand, by sliding the hand in a longitudinal direction of the grip portion 211. Therefore, an operator can smoothly perform a shift between an angle operation and a tilt operation, which enables to perform a more intuitive operation.

Herein, the operation surface 212 of the grip portion 211 on which the first operation element 201 and the second operation element 202 are provided is inclined toward the driver's seat 341 in the left-right direction D3 of the machine body 30. In summary, in the present embodiment, as illustrated in FIG. 4, since the operation lever 21 is provided on the right side of the driver's seat 341, the operation surface 212 is inclined toward the left side (the side of the driver's seat 341) in the left-right direction D3. This allows an operator to smoothly perform a shift between an angle operation and a tilt operation, while performing an angle operation and a tilt operation with the same finger (e.g., the thumb (first finger)), which enables to perform a more intuitive operation.

Further, in the present embodiment, as described above, the third operation element 203 is further provided, in addition to the first operation element 201 and the second operation element 202. That is, the operation system 2 according to the present embodiment includes the third operation element 203 that is disposed on the grip portion 211, and accepts an operation of switching a vehicle speed of the traveling unit 31 of the work machine 3. This allows an operator to intuitively perform an operation of changing a vehicle speed, when operating the soil removal device 35 by the operation lever 21.

More specifically, the third operation element 203 is disposed, on the operation surface 212, at a lower position of the first operation element 201 and the second operation element 202. Further, the third operation element 203 is disposed, on the operation surface 212, on a side opposite to the driver's seat 341 (in the present embodiment, on the right side) with respect to the first operation element 201 and the second operation element 202. That is, as illustrated in FIG. 6, the third operation element 203 is disposed at a position close to the right side on the operation surface 212. This makes it easy for an operator to perform an operation of the soil removal device 35 by the first operation element 201 or the second operation element 202, and an operation of changing a vehicle speed by the third operation element 203 without mistake.

Further, in the present embodiment, as described above, the fourth operation element 204 is further provided, in addition to the first operation element 201 and the second operation element 202. That is, the operation system 2 according to the present embodiment includes the fourth operation element 204 that is disposed on the grip portion 211, and accepts an operation for automatically controlling the blade 351 of the soil removal device 35. This allows an operator to intuitively perform an operation of automatically controlling the blade 351, when operating the soil removal device 35 by the operation lever 21.

More specifically, the fourth operation element 204 is disposed, on the grip portion 211, on a surface opposite to the side of the operation surface 212 on which the first operation element 201 and the second operation element 202 are provided. This makes it easy for an operator to perform an operation for manually controlling the blade 351 by the first operation element 201 or the second operation element 202, and an operation for automatically controlling the blade 351 by the fourth operation element 204 without mistake.

In the present embodiment, each of the first operation element 201 and the second operation element 202 is a slide switch operable in both of operation directions with respect to a neutral position, as a reference. That is, as illustrated in FIG. 6, any of the first operation element 201 and the second operation element 202 is a slide switch which is in a neutral position in a non-operation state, and is operable in both of operation directions from the neutral position. Further, in the first operation element 201, a rotation amount (rotation angle) of the blade 351 in angle movement is determined according to an operation amount from the neutral position, and in the second operation element 202, a rotation amount (rotation angle) of the blade 351 in tilt movement is determined according to an operation amount from the neutral position.

According to this configuration, an operator can intuitively perform each of an angle operation and a slide operation, which improves operability. Particularly, determining a rotation amount of the blade 351 according to an operation amount from the neutral position enables to intuitively perform an angle operation and a tilt operation.

Further, the operation direction (of the first operation element 201 and the second operation element 202) is a direction along the left-right direction D3 of the machine body 30. That is, as illustrated in FIG. 6, any of the first operation element 201 and the second operation element 202 is operable from the neutral position in both of the left-right direction D3 (leftward and rightward). In the present embodiment, as an example, when the first operation element 201 is operated rightward, the blade 351 performs angle movement in such a way that a right end portion thereof is located rearward (a left end portion thereof is located forward), and when the first operation element 201 is operated leftward, the blade 351 performs angle movement in such a way that the left end portion thereof is located rearward (the right end portion thereof is located forward). When the second operation element 202 is operated rightward, the blade 351 performs tilt movement in such a way that the right end portion thereof is located downward (the left end portion thereof is located upward), and when the second operation element 202 is operated leftward, the blade 351 performs tilt movement in such a way that the left end portion thereof is located downward (the right end portion thereof is located upward).

This allows an operator to more intuitively perform each of an angle operation and a slide operation, which improves operability.

### [4] Movement of Operation System

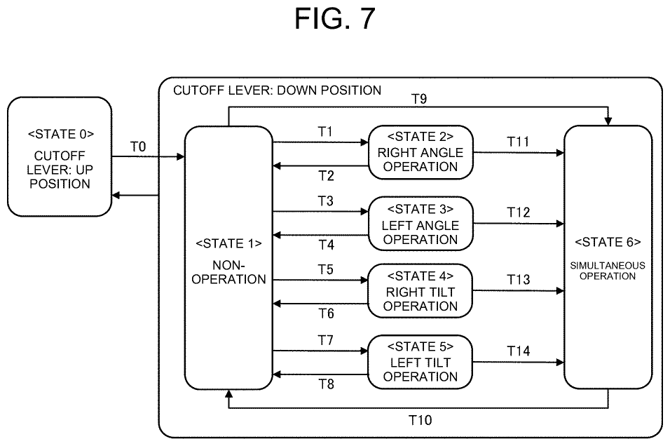

Next, movement of the operation system 2 according to the present embodiment is described with reference to FIGS. 5 and 7.

FIG. 7 is a state transition diagram indicating a transition condition of a state of the operation system 2. In FIG. 7, an arrow indicates a transition of a state, and, for example, a transition T1 represents a transition from <state 1> to <state 2>, and a transition T4 represents a transition from <state 3> to <state 1>.

Herein, <state 0> is a state (locked state) in which the cutoff lever 25 is at an up position, and any of <state 1> to <state 6> is a state (lock released state) in which the cutoff lever 25 is at a down position. Further, <state 1> is a state in which both of the first operation element 201 and the second operation element 202 are not operated (at a neutral position), and <state 5> is a simultaneous operated state in which both of the first operation element 201 and the second operation element 202 are simultaneously operated. <State 2> is a state in which the first operation element 201 is operated rightward, and <state 3> is a state in which the first operation element 201 is operated leftward. <State 4> is a state in which the second operation element 202 is operated rightward, and <state 5> is a state in which the second operation element 202 is operated leftward. <State 2> to <state 5> are a single operated state in which one of the first operation element 201 and the second operation element 202 is operated.

First, movement of the operation system 2 in a state (lock released state) in which the cutoff lever 25 is at a down position is described.

When a transition (T1, T3) is made from <state 1> in which both of the first operation element 201 and the second operation element 202 are not operated to <state 2> or <state 3> by a single operation of the first operation element 201, the controller 24 controls the control valve 445 by the driver 23, and switches the switching valve 43 to the side of the angle cylinder 353. Further, the controller 24 controls the control valves 441 and 443 by the driver 23 according to an operation amount of the first operation element 201, controls the direction switching valve 42, and supplies hydraulic oil from the hydraulic pump 41 to the angle cylinder 353 via the direction switching valve 42 and the switching valve 43. Thus, the angle cylinder 353 is driven according to an operation amount of the first operation element 201 that accepts an angle operation, and angle movement of the blade 351 is achieved.

Likewise, when a transition (T5, T7) is made from <state 1> in which both of the first operation element 201 and the second operation element 202 are not operated to <state 4> or <state 5> by a single operation of the second operation element 202, the controller 24 controls the control valve 445 by the driver 23, and switches the switching valve 43 to the side of the tilt cylinder 354. Further, the controller 24 controls the control valves 441 and 443 by the driver 23 according to an operation amount of the second operation element 202, controls the direction switching valve 42, and supplies hydraulic oil from the hydraulic pump 41 to the tilt cylinder 354 via the direction switching valve 42 and the switching valve 43. Thus, the tilt cylinder 354 is driven according to an operation amount of the second operation element 202 that accepts a tilt operation, and tilt movement of the blade 351 is achieved.

When a transition (T2, T4, T6, T8) is made from a single operated state <states 2 to 5> of the first operation element 201 or the second operation element 202 to <state 1> in which both of the first operation element 201 and the second operation element 202 are not operated, the controller 24 controls the control valves 441 and 443 by the driver 23, controls the direction switching valve 42, stops supply of hydraulic oil from the hydraulic pump 41 to the angle cylinder 353 or the tilt cylinder 354, and stops angle movement or tilt movement of the blade 351.

On the other hand, when a transition (T9) is made from <state 1> in which both of the first operation element 201 and the second operation element 202 are not operated to <state 6> by operations of both of the first operation element 201 and the second operation element 202, the controller 24 controls the control valves 441 and 443 by the driver 23, controls the direction switching valve 42, prohibits supply of hydraulic oil from the hydraulic pump 41 to the angle cylinder 353 and the tilt cylinder 354, and prohibits angle movement and tilt movement of the blade 351. Thus, at a simultaneous operation time of the first operation element 201 and the second operation element 202, both of angle movement and tilt movement of the blade 351 are prohibited.

When a transition (T10) is made from a simultaneous operated state (state 6) of the first operation element 201 and the second operation element 202 to <state 1> in which both of the first operation element 201 and the second operation element 202 are not operated, the controller 24 continues a state in which supply of hydraulic oil to the angle cylinder 353 and the tilt cylinder 354 is prohibited by the driver 23. Thus, a state in which both of angle movement and tilt movement of the blade 351 are prohibited is continued.

Further, when a transition (T11 to T14) is made from a single operated state (states 2 to 5) of the first operation element 201 or the second operation element 202 to a simultaneous operated state (state 6) of the first operation element 201 and the second operation element 202, the controller 24 controls the control valves 441 and 443 by the driver 23, controls the direction switching valve 42, prohibits supply of hydraulic oil from the hydraulic pump 41 to the angle cylinder 353 and the tilt cylinder 354, and prohibits angle movement and tilt movement of the blade 351. Thus, both of angle movement and tilt movement of the blade 351 are prohibited, even in a case where a transition is made from a single operated state of the first operation element 201 and the second operation element 202 to a simultaneous operated state of the first operation element 201 and the second operation element 202.

Further, in the present embodiment, in a case where a transition (TO) is made from a locked state (state 0) in which the cutoff lever 25 is at an up position to a lock released state by an operation of the cutoff lever 25 to a down position, a transition to <state 1> is made without fail. Thus, even in a case where the cutoff lever 25 is operated from an up position to a down position in a state in which one of the first operation element 201 and the second operation element 202 is operated, a single operated state (states 2 to 5) of the first operation element 201 or the second operation element 202 is prohibited, and both of angle movement and tilt movement of the blade 351 are prohibited.

As described above, in the operation system 2 according to the present embodiment, angle movement and tilt movement are prohibited at a simultaneous operation time (state 6) of the first operation element 201 and the second operation element 202. This makes it easy to prevent an unintended manual operation of the blade 351 by an operator due to a simultaneous operation of the individually provided first operation element 201 and second operation element 202.

Further, when a transition is made from a single operated state (states 2 to 5) in which one of the first operation element 201 and the second operation element 202 is operated to a simultaneous operated state (state 6) in which both of the first operation element 201 and the second operation element 202 are operated, angle movement and tilt movement are prohibited. This makes it easy to securely prevent an unintended manual operation of the blade 351 by an operator due to a simultaneous operation of the individually provided first operation element 201 and second operation element 202.

Further, in the present embodiment, a transition from a simultaneous operated state (state 6) of the first operation element 201 and the second operation element 202 to a single operated state (states 2 to 5) of the first operation element 201 or the second operation element 202 is not allowed. In summary, angle movement and tilt movement are prohibited, also in a single operated state in a case where a transition is made from a simultaneous operated state to a single operated state. This enable to more securely prevent an unintended manual operation of the blade 351 by an operator.

Further, the operation system 2 according to the present embodiment includes the cutoff lever 25 that switches between a locked state in which movement of the work machine 3 is restricted, and a lock released state in which movement of the work machine 3 is not restricted. Herein, angle movement and tilt movement are prohibited also in a case where the operation system 2 is switched from a locked state to a lock released state during continuation of a single operated state. This enables to more securely prevent an unintended manual operation of the blade 351 by an operator.

Herein, a transition detection time for detecting transitions T1 to T14 by the controller 24 can be set (adjusted) as a parameter. However, transitions (T11 to T14) from a single operated state (states 2 to 5) of the first operation element 201 or the second operation element 202 to a simultaneous operated state (state 6) of the first operation element 201 and the second operation element 202 assume a condition in which an erroneous operation is performed. Therefore, it is preferable to set a transition detection time for the transitions T11 to T14 long, as compared with the other transitions T1 to T10.

In the operation system 2 according to the present embodiment, the automatic control unit 22 automatically controls the blade 351 in the automatic control mode. Specifically, the automatic control unit 22 performs automatic control of lifting movement and tilt movement of the blade 351, based on a difference between design data, and an actual measurement value about the blade 351 to be measured by an angle sensor, a height sensor, and the like of the blade 351.

In this way, when one of the first operation element 201 and the second operation element 202 is operated in a state in which the automatic control unit 22 is in the automatic control mode, the automatic control unit 22 stops automatic control of the blade 351.

Specifically, as illustrated in FIG. 4, the four control valves 441 to 444 are provided on a pilot oil supply path to the direction switching valve 42 via the shuttle valves 451 and 452. Therefore, a pilot signal on a high-pressure side between the control valves 441 and 442 is input to the direction switching valve 42, and a pilot signal on a high-pressure side between the control valves 443 and 444 is input to the direction switching valve 42.

Normally, as far as the automatic control unit 22 is in the automatic control mode, the control valves 442 and 444 are on a high-pressure side. Therefore, pilot oil is supplied, to the direction switching valve 42, from the control valves 442 and 444 to be automatically controlled by the automatic control unit 22. In this state, when one of the first operation element 201 and the second operation element 202 is operated, the control valves 441 and 443 are brought to a high-pressure side, and pilot oil is supplied, to the direction switching valve 42, from the control valves 441 and 443 to be controlled by the driver 23 in response to an operation of the first operation element 201 or the second operation element 202.

In this way, the operation system 2 according to the present embodiment includes the automatic control unit 22 that automatically controls the blade 351. When one of the first operation element 201 and the second operation element 202 is operated during automatic control of the blade 351, automatic control of the blade 351 is stopped. In summary, a manual operation of the blade 351 by the first operation element 201 or the second operation element 202 is prioritized to automatic control of the blade 351. Therefore, even during automatic control, an operator can easily shift to a manual operation of the blade 351 by operating the first operation element 201 or the second operation element 202.

Further, in the present embodiment, as described above, in a case where automatic control of the blade 351 is stopped by an operation of the first operation element 201 or the second operation element 202, automatic control is resumed by the automatic control unit 22 by setting, as a trigger, termination of a single operation of the first operation element 201 or the second operation element 202. This enables to easily shift (return) to an automatic operation of the blade 351, while prioritizing a manual operation to automatic control.

### [5] Modifications

In the following, modification examples of the first embodiment are described. The modification examples described below can be combined as necessary.

The operation system 2 according to the present disclosure is not limited to an embodiment configured of a hydraulic circuit as described in the first embodiment, and may be embodied, for example, by an operation system 2 including a computer system. The computer system includes, as a main component, one or more processors as hardware, and one or more memories. By causing the processor to execute a program recorded in the memory of the computer system, the operation system 2 according to the present disclosure is achieved. The program may be recorded in advance in the memory of the computer system, may be provided through an electrical communication line, or may be recorded in a non-transitory recording medium such as a memory card readable by the computer system, an optical disc, or a hard disk drive, and provided. Further, a part or all functional units included in the operation system 2 may be configured of an electronic circuit.

Further, a configuration in which at least a part of the functions of the operation system 2 are integrated within one housing is not essential in the operation system 2, and constituent elements of the operation system 2 may be provided in a plurality of housings in a distributive manner. Further, at least a part of the functions of the operation system 2 may be achieved by a cloud (cloud computing) or the like.

Further, a working fluid is not limited to hydraulic oil, and, for example, may be a gas such as air, or another fluid. In a case where a working fluid is air, a pneumatic actuator to be driven by an air pressure such as compressed air is used as an actuator such as the angle cylinder 353 and the tilt cylinder 354.

Further, the driving unit 34 is not limited to a cabin type, and may be, for example, a canopy type, a floor type, or the like.

Further, a power source of the work machine 3 is not limited to a diesel engine. For example, a power source of the work machine 3 may be an engine other than a diesel engine, may be a motor (electric motor), or may be a hybrid power source that includes an engine and a motor (electric motor).

### [Supplementary Note of Invention]

Hereinafter, an overview of the invention to be extracted from the above-described embodiment is added. Note that, each configuration and each processing function described in the following supplementary notes can be selected and optionally combined.

### <Supplementary Note 1>

An operation system for a work machine provided with a soil removal device including a blade, including:
an operation lever that accepts a lifting operation for causing the blade to perform lifting movement;
a first operation element that accepts an operation for causing the blade to perform angle movement of rotationally swinging the blade around a first axis along a vertical direction; and
a second operation element that accepts an operation for causing the blade to perform tilt movement of rotationally swinging the blade around a second axis along a horizontal direction, wherein
the first operation element and the second operation element are provided individually.

### <Supplementary Note 2>

The operation system according to supplementary note 1, wherein
the angle movement and the tilt movement are prohibited at a simultaneous operation time of the first operation element and the second operation element.

### <Supplementary Note 3>

The operation system according to supplementary note 2, wherein
the angle movement and the tilt movement are prohibited, when a transition is made from a single operated state in which one of the first operation element and the second operation element is operated to a simultaneous operated state in which both of the first operation element and the second operation element are operated.

### <Supplementary Note 4>

The operation system according to supplementary note 3, wherein
the angle movement and the tilt movement are prohibited also in the single operated state in a case where a transition is made from the simultaneous operated state to the single operated state.

### <Supplementary Note 5>

The operation system according to supplementary note 3 or 4, further including
a cutoff lever that switches between a locked state in which movement of the work machine is restricted, and a lock released state in which movement of the work machine is not restricted, wherein
the angle movement and the tilt movement are prohibited also in a case where the operation system is switched from the locked state to the lock released state during continuation of the single operated state.

### <Supplementary Note 6>

The operation system according to any one of supplementary notes 1 to 5, further including:
an automatic control unit that automatically controls the blade, wherein
automatic control of the blade is stopped when one of the first operation element and the second operation element is operated during automatic control of the blade.

### <Supplementary Note 7>

The operation system according to any one of supplementary notes 1 to 6, wherein
the first operation element and the second operation element are disposed adjacent to each other.

### <Supplementary Note 8>

The operation system according to any one of supplementary notes 1 to 7, wherein
the first operation element and the second operation element are disposed on a grip portion of the operation lever.

### <Supplementary Note 9>

The operation system according to supplementary note 8, wherein
the first operation element and the second operation element are disposed side by side in a longitudinal direction of the grip portion.

### <Supplementary Note 10>

The operation system according to supplementary note 8 or 9, wherein
an operation surface of the grip portion on which the first operation element and the second operation element are provided is inclined toward a driver's seat in a left-right direction of a machine body.

### <Supplementary Note 11>

The operation system according to any one of supplementary notes 8 to 10, further including
a third operation element that is disposed on the grip portion, and accepts an operation of switching a vehicle speed of a traveling unit of the work machine.

### <Supplementary Note 12>

The operation system according to any one of supplementary notes 1 to 11, wherein
each of the first operation element and the second operation element is a slide switch operable in both of operation directions with respect to a neutral position as a reference.

### <Supplementary Note 13>

The operation system according to supplementary note 12, wherein
the operation direction is a direction along a left-right direction of a machine body.

### <Supplementary Note 14>

A work machine including:
the operation system according to any one of supplementary notes 1 to 13; and
a machine body including the soil removal device.

### REFERENCE SIGNS LIST

2 Operation system
3 Work machine
21 Operation lever
22 Automatic control unit
25 Cutoff lever
30 Machine body
31 Traveling unit
35 Soil removal device
201 First operation element
202 Second operation element
203 Third operation element
211 Grip portion
212 Operation surface
341 Driver's seat
351 Blade
Ax1 First axis
Ax2 Second axis
D3 Left-right direction

1. An operation system for a work machine provided with a soil removal device including a blade, comprising:
an operation lever that accepts a lifting operation for causing the blade to perform lifting movement;
a first operation element that accepts an operation for causing the blade to perform angle movement of rotationally swinging the blade around a first axis along a vertical direction; and
a second operation element that accepts an operation for causing the blade to perform tilt movement of rotationally swinging the blade around a second axis along a horizontal direction, wherein
the first operation element and the second operation element are provided individually.

2. The operation system according to claim 1, wherein
the angle movement and the tilt movement are prohibited at a simultaneous operation time of the first operation element and the second operation element.

3. The operation system according to claim 2, wherein
the angle movement and the tilt movement are prohibited, when a transition is made from a single operated state in which one of the first operation element and the second operation element is operated to a simultaneous operated state in which both of the first operation element and the second operation element are operated.

4. The operation system according to claim 3, wherein
the angle movement and the tilt movement are prohibited also in the single operated state in a case where a transition is made from the simultaneous operated state to the single operated state.

5. The operation system according to claim 3, further comprising
a cutoff lever that switches between a locked state in which movement of the work machine is restricted, and a lock released state in which movement of the work machine is not restricted, wherein
the angle movement and the tilt movement are prohibited also in a case where the operation system is switched from the locked state to the lock released state during continuation of the single operated state.

6. The operation system according to claim 1, further comprising:
an automatic control unit that automatically controls the blade, wherein
automatic control of the blade is stopped when one of the first operation element and the second operation element is operated during automatic control of the blade.

7. The operation system according to claim 1, wherein
the first operation element and the second operation element are disposed adjacent to each other.

8. The operation system according to claim 1, wherein
the first operation element and the second operation element are disposed on a grip portion of the operation lever.

9. The operation system according to claim 8, wherein
the first operation element and the second operation element are disposed side by side in a longitudinal direction of the grip portion.

10. The operation system according to claim 8, wherein
an operation surface of the grip portion on which the first operation element and the second operation element are provided is inclined toward a driver's seat in a left-right direction of a machine body.

11. The operation system according to claim 8, further comprising
a third operation element that is disposed on the grip portion, and accepts an operation of switching a vehicle speed of a traveling unit of the work machine.

12. The operation system according to claim 1, wherein
each of the first operation element and the second operation element is a slide switch operable in both of operation directions with respect to a neutral position as a reference.

13. The operation system according to claim 12, wherein
the operation direction is a direction along a left-right direction of a machine body.

14. A work machine comprising:
the operation system according to claim 1; and
a machine body including the soil removal device.
